(19) United States
(12) Patent Application Publication
(10) Pub. No.: US 2006/0104692 A1
(43) Pub. Date: May 18, 2006

(54) Electronic device handling apparatus and temperature application method in electronic device handling apparatus

(75) Inventor: Hiroto Nakamura, Tokyo (JP)

Correspondence Address: POSZ LAW GROUP, PLC, 12040 SOUTH LAKES DRIVE, SUITE 101, RESTON, VA, 20191, US

(73) Assignee: ADVANTEST CORPORATION, Tokyo (JP)

(21) Appl. No.: 11/290,827

(22) Filed: Dec. 1, 2005

Related U.S. Application Data
(63) Continuation of application No. PCT/JP03/07082, filed on Jun. 4, 2004.

(51) Int. Cl. B41J 3/36

(52) U.S. Cl. 400/88

(57) ABSTRACT

In a handler 1 capable of handling strip formats 2, a plurality of strip formats 2 are held in a magazine 3 and conveyed to inside a constant temperature chamber 15, and the strip formats 2 held in the magazine 3 are applied with a predetermined temperature.

According to the handler 1 as above, the constant temperature chamber 15 can be downsized and simplified and the maintainability can be improved.

### TECHNICAL FIELD

The present invention relates to an electronic device handling apparatus capable of handling electronic device assembly, such as a strip format including a plurality of IC devices or other electronic devices, to conduct a test on the plurality of electronic devices in the electronic device assembly, and a method of applying a temperature in the electronic device handling apparatus.

### BACKGOUND ART

When producing an electronic device, such as an IC device, an electronic device testing apparatus has been conventionally used for testing whether the produced electronic device is defective or not, etc. In such an electronic device testing apparatus, an electronic device handling apparatus called a handler conveys electronic devices, brings each of the respective electronic devices electrically contact with a test head under a predetermined temperature and, after conducting a test by a main testing device (tester), the electronic devices are classified to categories of good ones and defective ones, etc. in accordance with the test results.

As to a form of the electronic device to be tested, what obtained by packaging each electronic device separately (an IC device, etc.) is usually the case, however, to improve an efficiency of the test, an electronic device assembly, such as a strip format obtained by forming a plurality of electronic devices on a substrate or a tape (refer to FIG. 2(a), is tested in some cases.

Here, a handler of the related art for testing a strip format electronic device will be explained. As shown in FIG. 5, a handler 1P of the related art comprises a storage portion 11P for storing pre-test and post-test strip formats 2, a constant temperature chamber 15P for applying a predetermined temperature to the strip formats 2 including an upper portion of the test head 5, a loader section 12P for sending the pre-test strip formats 2 stored in the storage portion 11P to the constant temperature chamber 15P, and an unloader section 14P for taking out and classifying the post-test strip formats 2 subjected to a test in the constant temperature chamber 15P. Note that the strip formats 2 in the storage portion 11P are stored in a state of being held in a magazine 3 capable of holding a plurality of strip formats 2 by stacking them.

The pre-test strip formats 2 are taken out one by one in the loader section 12P and conveyed to the constant temperature chamber 15P. After staying in the constant temperature chamber 15P for predetermined time until reaching to a predetermined temperature, the strip formats 2 are pressed against the test head 5 and tested. When the test finishes, the post-test strip formats 2 are loaded in predetermined magazines 3 and classified to categories, such as good ones and defective ones, in the unloader section 14P in accordance with the test results.

In the handler 1P of the related art, to make the strip formats 2 stay effectively in the constant temperature chamber 15P, a plurality of strip formats 2 are stepwise fed in a piled up state leaving predetermined intervals of not contacting with one another to stay in the constant temperature chamber 15P. To make the strip formats 2 stay as such, then the constant temperature chamber 15P becomes large and a device for stepwise feeding the strip formats 2 as above requires a complicated configuration. Furthermore, since the strip formats are handled in a naked state, maintenance becomes difficult in the case of a trouble.

### DISCLOSURE OF THE INVENTION

The present invention was made in consideration of the above circumstances and has as an object thereof to provide an electronic device handling apparatus and a temperature application method in an electronic device handling apparatus capable of downsizing and simplifying a temperature application portion and improving maintainability.

To attain the above object, according to the first invention, there is provided an electronic device handling apparatus capable of handling an electronic device assembly for testing electronic devices of the electronic device assembly, comprising a storage portion capable of storing electronic device assembly holder capable of holding a plurality of electronic device assemblies; a temperature application portion capable of applying a predetermined temperature to electronic device assemblies held in the electronic device assembly holder; and a holder conveyor capable of conveying the electronic device assembly holder from the storage portion to the temperature application portion (1).

Here, the expression “conveying to the temperature applying portion” includes both of “conveying to inside the temperature applying portion” and “conveying to right in front of the temperature applying portion”.

In the electronic device handling apparatus according to the invention (1), when applying a temperature to an electronic device assembly held in the electronic device assembly holder, a conventional stepwise feeder having a complicated configuration is not necessary and the configuration in the temperature application portion can be simplified. Also, comparing with such a stepwise feeder, the electronic device assembly holder is capable of holding electronic device assemblies at narrow pitches, so that the number of electronic device assembly per unit volume can be increased in the temperature application portion and downsizing of the temperature application portion can be attained.

Furthermore, electronic device assemblies are applied with a temperature in a state of being held in the electronic device assembly holder and not in a naked state, so that troubles are reduced and the maintainability is good.

On the other hand, the conveyor device does not convey electronic device assemblies themselves but conveys the electronic device assembly holder, so that it is possible to convey easily with a simple configuration.

In the above invention (1), the temperature application portion may apply a predetermined temperature to electronic device assemblies held in an electronic device assembly holder conveyed by the holder conveyor.

(2). According to the invention (2), a reloading device at an inlet of the temperature application portion becomes unnecessary.

In the above invention (2), preferably, the temperature application portion is provided with a holder conveyor for conveying the electronic device assembly holder, so that an electronic device assembly holder conveyed thereto by the holder conveyor passes through the temperature application portion and taken out from the temperature application portion (3). According to the invention (3), it is possible to handle the electronic device assembly holder smoothly.

In the above invention (1), the temperature application portion may be provided with a temperature application electronic device assembly holder and, it may furthermore comprise a reloading device for reloading electronic device assemblies held in a conveyor electronic device assembly holder conveyed by the holder conveyor to the temperature application electronic device assembly holder (4).

According to the above invention (4), the temperature application electronic device assembly holder can be set at a predetermined temperature in advance, so that temperature application to electronic device assemblies can be performed in a short time and the test efficiency can be improved.

In the above invention (4), the electronic device assembly holder may comprise an opening portion capable of letting in and out electronic device assemblies and an electronic device assembly holding portion for holding a plurality of electronic device assemblies inserted from the opening portion at predetermined pitches, and electronic device assembly holding pitches in the conveyor electronic device assembly holder and electronic device assembly holding pitches in the temperature application electronic device assembly holder are set to be substantially the same; the holder conveyor may convey the conveyor electronic device assembly holder to a position where an opening portion of the conveyor electronic device assembly holder faces an opening portion of the temperature application electronic device assembly holder; and the reloading device may reload electronic device assemblies held by the conveyor electronic device assembly holder by sliding them to the temperature application electronic device assembly holder (5).

According to the above invention (5), since electronic device assemblies can be extremely easily reloaded from the conveyor electronic device assembly holder to temperature application electronic device assembly holder, the electronic device assemblies can be introduced to the temperature application portion very efficiently comparing with the case of loading electronic device assembly one by one to a stepwise feeder as in the related art.

In the above inventions (1 to 5), the electronic device assembly may be a strip format, and the electronic device assembly holder may be configured to be capable of holding a plurality of strip formats horizontally at predetermined pitches (6). Note that the present invention is not limited to that and, for example, the electronic device assembly may be a wafer, a tray holding a plurality of electronic devices or, particularly, a test tray able to be attached to the test head and capable of bringing electronic devices held therein electrically contact with the test head.

Secondary, according to the second invention, there is provided a temperature application method for applying a predetermined temperature to an electronic device assembly in an electronic device handling apparatus capable of handling an electronic device assembly for testing electronic devices of the electronic device assembly, comprising the steps of conveying electronic device assemblies to a temperature application portion by holding them in an electronic device assembly holder capable of holding a plurality of electronic device assemblies; and applying a predetermined temperature to electronic device assemblies held in the electronic device assembly holder (7).

Here, the expression “conveying to the temperature applying portion” includes both of “conveying to inside the temperature applying portion” and “conveying to right in front of the temperature applying portion”.

In the temperature application method in the electronic device handling apparatus according to the above invention (7), a conventional stepwise feeder having a complicated configuration is not necessary and the configuration in the temperature application portion can be simplified. Also, comparing with such a stepwise feeder, the electronic device assembly holder is capable of holding electronic device assemblies at narrow pitches, so that the number of electronic device assembly per unit volume can be increased in the temperature application portion and downsizing of the temperature application portion can be attained.

Furthermore, the electronic device assemblies are applied with a temperature in a state of being held in the electronic device assembly holder and not in a naked state, so that troubles are reduced and the maintainability is good.

On the other hand, as for the conveying, the electronic device assembly holder instead of electronic device assemblies themselves can be conveyed, so that it is possible to simplify the conveyor device and to convey easily.

In the above invention (7), electronic device assemblies held by the conveyor electronic device assembly holder conveyed to the temperature application portion may be reloaded to a temperature application electronic device assembly holder provided to the temperature application portion, and a predetermined temperature may be applied to the electronic device assemblies held by the temperature application electronic device assembly holder (8).

According to the above invention (8), the temperature application electronic device assembly holder can be set to a predetermined temperature in advance, so that temperature application to electronic device assembly can be performed in a short time and the test efficiency can be improved.

Note that in the above invention (7), a predetermined temperature may be applied to electronic device assemblies held in the electronic device assembly holder conveyed to the temperature application portion. Due to this, a reloading step at the inlet of the temperature application portion becomes unnecessary.

### BRIEF DESCRIPTION OF DRAWINGS

FIG. 1 is an overall view from the side of an electronic device testing apparatus including a handler according to a first embodiment of the present invention.

FIG. 2(a) is a perspective view showing an example of a strip format, and FIG. 2(b) is a perspective view showing an example of a magazine.

FIG. 3 is a schematic perspective view for explaining handling of magazines and strip formats in the handler according to the first embodiment of the present invention.

FIG. 4 is a schematic perspective view for explaining handling of magazines and strip formats in a handler in a second embodiment of the present invention.

FIG. 5 is a schematic perspective view for explaining handling of magazines and strip formats in a handler of the related art.

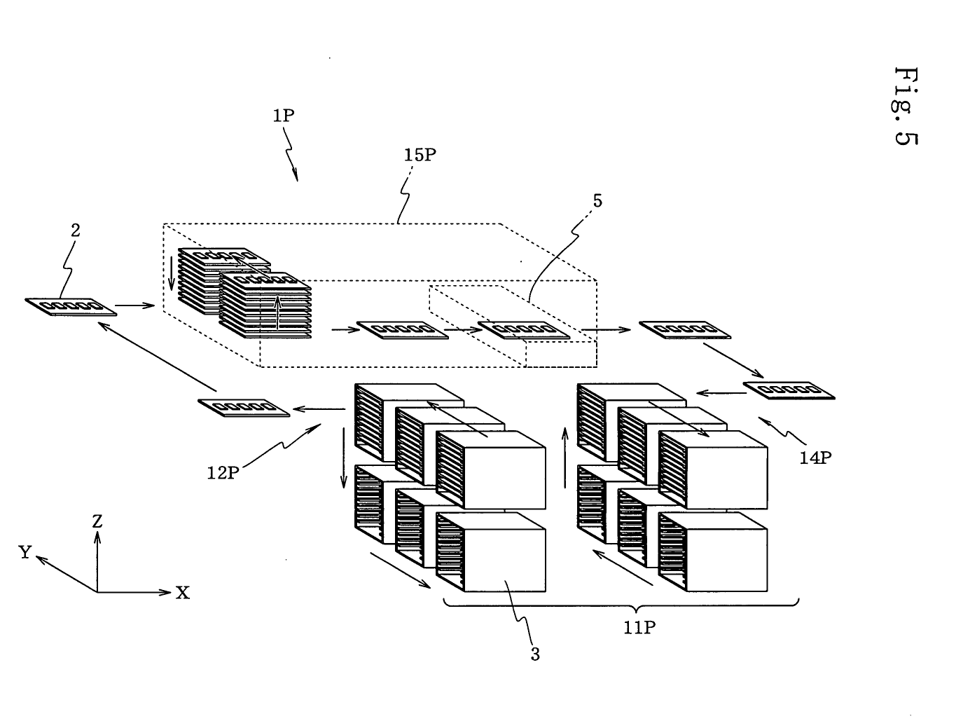

### BEST MODE FOR CARRYING OUT THE INVENTION

Below, embodiments of the present invention will be explained based on the drawings.

### FIRST EMBODIMENT

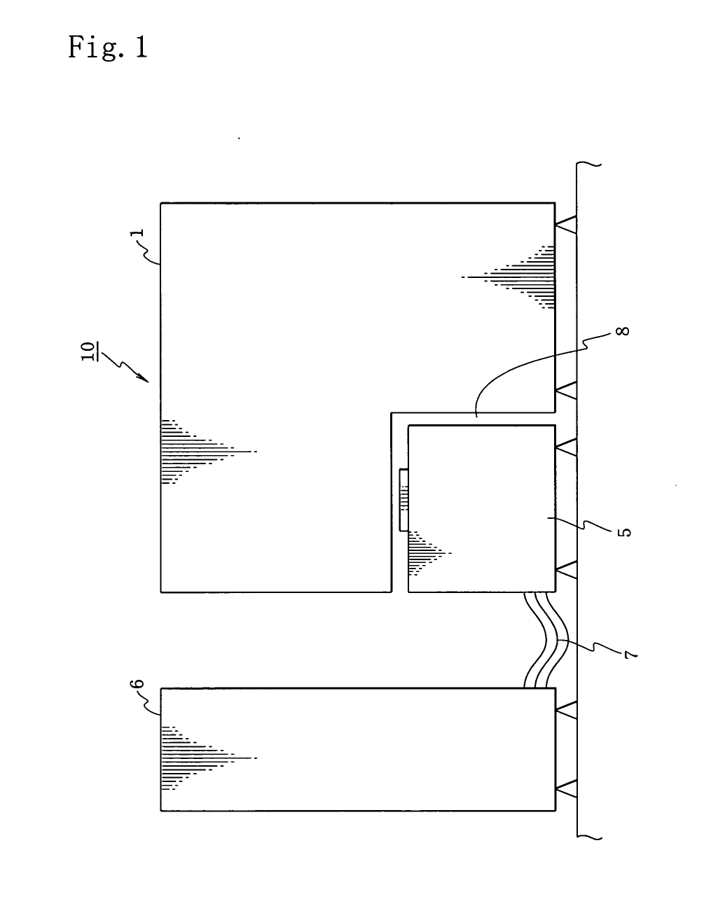

First, an overall configuration of the electronic device testing apparatus provided with an electronic device handling apparatus (herein after, referred to as “a handler”) according to the first embodiment of the present invention will be explained. As shown in FIG. 1, an electronic device testing apparatus 10 comprises a handler 1, a test head 5 and a main testing device 6. The handler 1 performs an operation of successively conveying electronic devices to be tested to sockets provided on the test head 5, classifying electronic devices finished with the test in accordance with the test results and storing to predetermined holders.

The sockets provided on the test head 5 are electrically connected to the main testing device 6 through a cable 7, connects electronic devices attached detachably to the sockets to the main testing device 6 through the cable 7 and conducts a test on the electronic devices by a test electric signal from the main testing device 6.

In the lower portion of the handler 1, a control device for mainly controlling the handler 1 is incorporated and a space 8 is provided to a part thereof. The test head 5 is placed in a freely replaceable way in the space 8, and electronic devices can be mounted on the sockets on the test head 5 through a through hole formed on the handler 1.

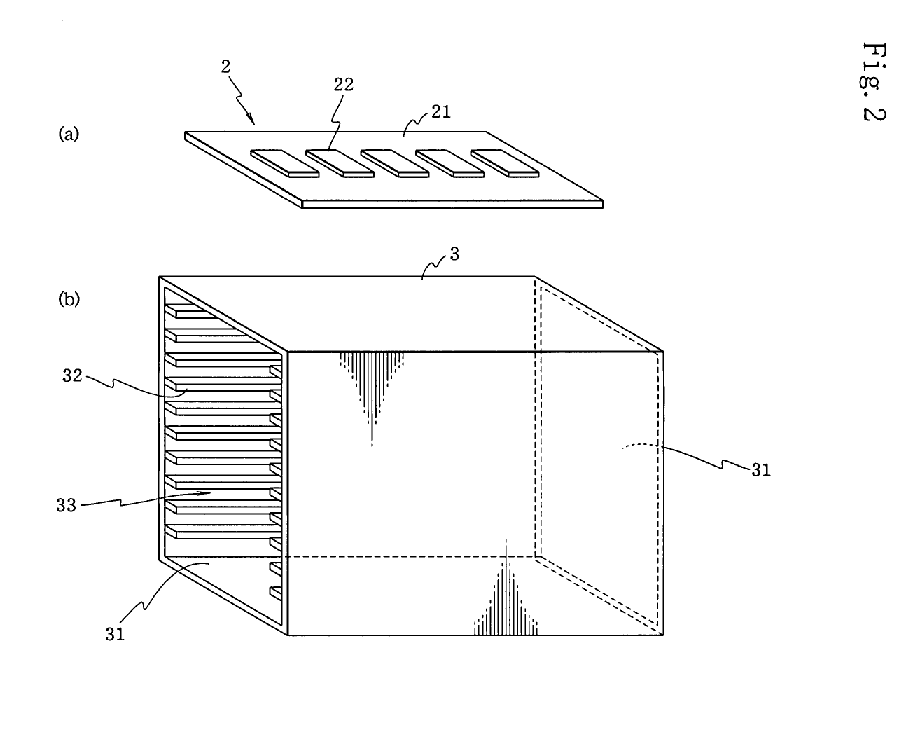

Note that, in the present embodiment, a strip format 2 as shown in FIG. 2(a) is tested, and the strip format 2 is held in the magazine 3 as shown in FIG. 2(b).

The strip format 2 comprises, as shown in FIG. 2(a), a substrate (or a tape) 21 and a plurality of electronic devices 22, such as IC devices, formed on the substrate 21. Since external terminals of the electronic devices 22 expose on the lower surface of the substrate 21 in the strip format 2, the electronic devices 22 can be tested in a state of the strip format 2.

The magazine 3 is shaped to be a quadratic cylinder as a whole as shown in FIG. 2(b) and has opening portions 31 and 31 capable of letting in and out the strip formats 2 and a plurality of convex ridges 32 formed horizontally at predetermined pitches on the inner sidewalls. The plurality of convex ridges 32 compose a strip format holding portion 33. The strip format holding portion 33 holds a plurality of strip formats 2 inserted from the opening 31 horizontally at predetermined pitches.

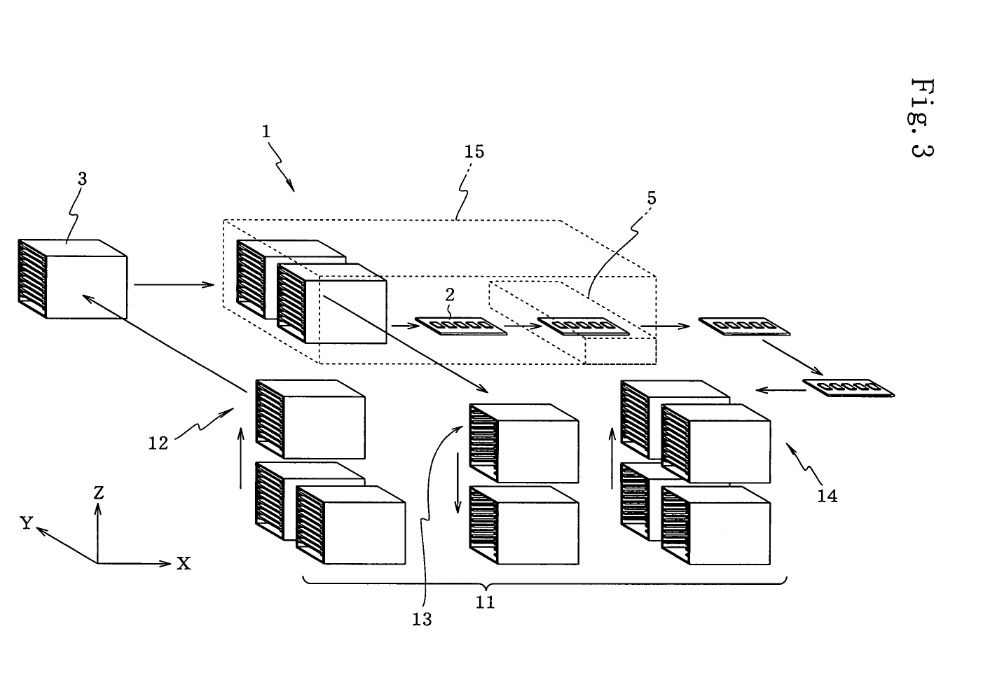

The handler 1 comprises, as shown in FIG. 3, a storage portion 11, a loader section 2, an empty magazine collector section 13, an unloader section 14, and a constant temperature chamber 15.

The storage portion 11 stores magazines 3 holding pre-test strip formats 2, empty magazines 3, and magazines 3 holding post-test strip formats 2. The storage portion 11 is provided with a conveyor device for conveying magazines 3 in the Y-axis direction and an elevator for moving magazines 3 up and down in the Z-axis direction (not shown).

The loader section 12 is a portion for sending magazines 3 holding pre-test strip formats 2 from the storage portion 11 into the constant temperature chamber 15 and provided with a conveyor device for conveying the magazines 3 in the Y-axis direction and the Y-axis direction (not shown).

The empty magazine collector portion 13 is a portion for collecting empty magazines 3 from inside the constant temperature chamber 15 and returning them to the storage portion 11 and provided with a conveyor device for conveying the magazines 3 in the Y-axis direction (not shown).

The unloader section 14 is a portion for taking out and classifying post-test strip formats 2 subjected to a test in the constant temperature chamber 15 and provided with a conveyor device for conveying the strip formats 2 in the X-axis direction and Y-axis direction and inserting to prescribed magazines 3 (not shown).

The constant temperature chamber 15 is a portion for applying a predetermined temperature (high temperature or low temperature) to the strip formats 2 and conducting a test on the strip formats 2 and configured to include an upper portion of the test head 5. In the constant temperature chamber 15, a conveyor device for taking out the strip formats 2 from the magazine 3 and conveying them to above the test head 5 is provided (not shown). The constant temperature chamber 15 in the present embodiment is provided with a magazine inlet at one end portion in the X-axis direction (on the left side in FIG. 3), a strip format outlet at the other end portion in the X-axis direction (on the right side in FIG. 3), and a magazine outlet at the front portion (front side in FIG. 3).

The conveyor devices for conveying the magazines 3 may be any kind and, for example, conveyor devices using a belt capable of loading and moving the magazines 3, those obtained by combining a rail and a loading member capable of moving on the rail, or arms capable of holding and moving the magazines 3, etc. may be used.

The conveyor devices for conveying the strip formats 2 are not particularly limited either and, for example, a conveyor device using arms capable of holding and moving the strip formats 2 and a conveyor device capable of holding the strip formats 2 by suction and moving them, etc. may be used.

In the above handler 1, magazines 3 holding a plurality of pre-test strip formats 2 move in the Y-axis direction and upward in the Z-axis direction in the storage portion 11 and position at the loader section 12. Then, the magazines 3 move in the Y-axis direction and X-axis direction in the loader section 12 so as to be fed to inside the constant temperature chamber 15 from the magazine inlet of the constant temperature chamber 15.

After staying in the constant temperature chamber 15 for predetermined time until loaded strip formats 2 reach a predetermined temperature, the magazines 3 move in the Y-axis direction by an amount of about one magazine. The strip formats 2 held in the magazines 3 are successively taken out from the magazines 3 and conveyed to above the test head 5 and pressed against the sockets of the test head 5. A test electric signal is sent from the main testing device 6 to electronic devices 22 of the strip formats 2 attached to the sockets, so that the test is conducted.

When the test finishes, the strip formats 2 are taken out from the strip format outlet of the constant temperature chamber 15, moved in the Y-axis direction and X-axis direction in the unloader section 14 and inserted to predetermined magazines 3 to be classified to categories of good ones, defective ones and ones needed to be tested again, etc. in accordance with the test results. Empty magazines 3 for holding the post-test strip formats 2 move in the Z-axis direction from the storage portion 11 and position at the unloader section 14. At this time, the empty magazines 3 move in the Z-axis direction by one pitch at a time, so that the highest level of the empty levels in the strip format holding portion 33 positions at a constant position. Magazines 3 full of post-test strip formats 2 are taken out to outside of the handler 1.

On the other hand, when all strip formats 2 held in magazines 3 are taken out, the magazines 3 in the constant temperature chamber 15 are taken out from the magazine outlet of the constant temperature chamber 15, moved in the Y-axis direction in the empty magazine collector section 13 and stored in the storage portion 11. The stored empty magazines 3 may be used for holding next pre-test strip formats 2 or moved in the X-axis direction to the unloader section 14 side in the storage portion 11 for holding post-test strip formats 2.

In the above handler 1, when introducing the strip formats 2 into the constant temperature chamber 15, it is not necessary to take out strip formats 2 one by one from a magazine 3 to load them on a stepwise feeder as in the related art, and it is possible to apply a temperature to a large number of strip formats 2 at a time. Also, the above handler 1 does not need a stepwise feeder requiring a complicated configuration, so that the configuration inside and outside of the constant temperature chamber 15 can be simplified and pitches of the strip format holding portion 33 of the magazine 3 can be narrowed easily. Consequently, the number of strip formats 2 per unit volume in the constant temperature chamber 15 can be increased and downsizing of the constant temperature chamber 15 can be attained.

Furthermore, the strip formats 2 are applied with a temperature in a state of being housed in the magazine 3 and not in a naked state in the constant temperature chamber 15, so that troubles are reduced and the maintainability is good.

### SECOND EMBODIMENT

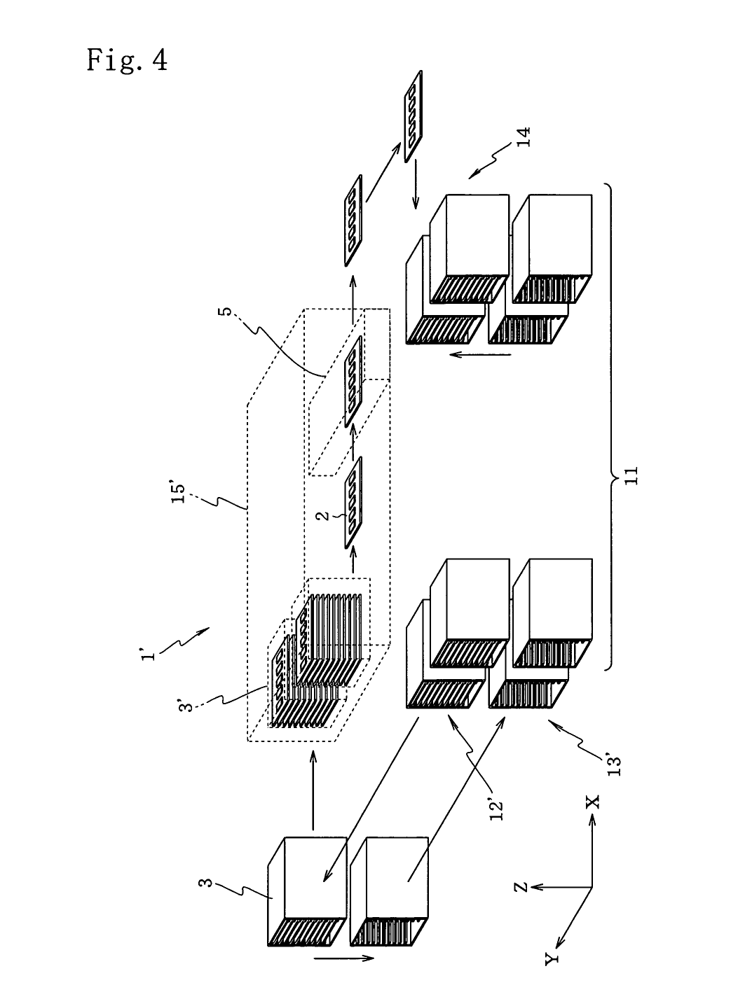

Next, a handler according to a second embodiment will be explained. As shown in FIG. 4, a handler 1′ according to the second embodiment comprises a storage portion 11, a loader section 12′, an empty magazine collector section 13′, an unloader section 14, and a constant temperature chamber 15′ as same as the handler 1 according to the first embodiment.

The storage portion 11, the unloader section 14 and the constant temperature chamber 15′ have approximately the same configurations as those in the handler 1 according to the first embodiment, but the constant temperature chamber 15′ is provided with a strip format inlet at one end portion in the X-axis direction (on the left side in FIG. 4) and a strip format outlet at the other end portion in the X-axis direction (on the right side in FIG. 4), and temperature application magazines 3′ are provided in advance near the strip format inlet inside the constant temperature chamber 15′. The temperature application magazines 3′ have the same configuration as those of magazines 3 for holding and conveying strip formats 2, so that pitches of the format holding portion 33 are same in both. In the present embodiment, two temperature application magazines 3′ are provided in parallel.

The loader section 12′ is a portion for moving magazines 3 holding pre-test strip formats 2 from the storage portion 11 to right in front of the constant temperature chamber 15′ and reloading strip formats 2 held in magazines 3 to the temperature application magazines 3′ in the constant temperature chamber 15′, and provided with a conveyor device for conveying the magazines 3 in the Y-axis direction and a reloading device (not shown) for reloading strip formats 2 from the magazines 3 to the temperature application magazines 3′. The reloading device is not particularly limited and, for example, a device capable of pushing out for sliding one or a plurality of strip formats 2 held in a magazine 3, etc. may be used.

The empty magazine collector section 13′ is a portion for collecting empty magazines 3 from right in front of the constant temperature chamber 15′ and returning them to the storage portion 11, and provided with a conveyor device for conveying magazines 3 in the Y-axis direction (not shown).

In the above handler 1′, a magazine holding a plurality of pre-test strip formats 2 moves from the storage portion 11 to the loader section 12′, moves in the Y-axis direction in the loader section 12′ and moves to right in front of the constant temperature chamber 15′. At this time, the magazine 3 moves right in front of the constant temperature chamber 15′ on the side where an empty temperature application magazine 3′ of the two temperature application magazines 3′ being parallel to each other in the constant temperature chamber 15′ positions, and an opening portion 31 of the magazine 3 and an opening portion 31 of the temperature application magazine 3′ are aligned to be facing to each other. Note that, from the not empty temperature application magazine 3′, strip formats 2 are taken out successively and conveyed 33 to above the test head 5.

Strip formats 2 held in the magazine 3 is reloaded to the temperature application magazine 3′ by a reloading device. Here, pitches of the strip format holding portions are same in the magazine 3 and temperature application magazine 3′ and the two are aligned, so that strip formats 2 held in the magazine 3 can be reloaded to the temperature application magazine 3′ only by sliding them. Furthermore, it is possible to reload a plurality of strip formats 2 at a time by sliding to the temperature application magazine 3′.

After staying in the constant temperature chamber 15′ for predetermined time until strip formats 2 reloaded to the temperature application magazine 3′ reach a predetermined temperature, they are successively taken out from the temperature application magazines 3′, conveyed to above the test head 5, and pressed against the sockets of the test head 5. A test electric signal is sent from the main testing device 6 to electronic devices 22 of the strip formats 2 attached to the sockets, so that the test is conducted. Handling of the post-head strip formats 2 is the same as that in the handler 1 according to the first embodiment.

On the other hand, when all of loaded strip formats 2 are taken out, the magazine 3 right in front of the constant temperature chamber 15′ moves downward in the Z-axis direction in the empty magazine collector section 13′, then, moves in the Y-axis direction, and stored in the storage portion 11. The empty magazine 3 stored in the empty magazine collector section 13′ may be used for holding next pre-test strip formats 2 or moved to the unloader section 14 side in the X-axis direction in the storage portion 11 to hold post-test strip formats 2.

Since the above handler 1′ does not need a stepwise feeder having a complicated configuration, the configuration in the constant temperature chamber 15′ can be simplified and pitches of strip format holding portion 33 of the temperature application magazine 3′ are narrowed easily. Therefore, the number of strip formats 2 per unit volume in the constant temperature chamber 15′ can be increased and downsizing of the constant temperature chamber 15′ can be attained.

Also, strip formats 2 are applied with a temperature in a state of being housed in the temperature application magazine 3′ and not in a naked state in the constant temperature chamber 15′, so that troubles are reduced and the maintainability is good.

Furthermore, in the above handler 1′, the temperature application magazines 3′ are provided in the constant temperature chamber 15′ and a temperature of the temperature application magazines 3′ is already at a predetermined temperature, so that temperature application to strip formats 2 can be performed in a short time comparing with that in the handler 1 according to the first embodiment, and the test efficiency can be improved.

Note that since strip formats 2 can be extremely easily reloaded from the magazine 3 to the temperature application magazine 3′ in a short time as explained above, the strip formats 2 can be introduced to inside the constant temperature chamber 15′ very efficiently comparing with the case of loading strip formats 2 one by one to a stepwise feeder as in the related art.

The embodiments explained above are described to facilitate understanding of the present invention and is not to limit the present invention. Accordingly, respective elements disclosed in the above embodiments include all design modifications and equivalents belonging to the technical scope of the present invention.

For example, in the above handlers 1 and 1′, an unsoak chamber may be provided next to the constant temperature chambers 15 and 15′. In the unsoak chamber, the strip formats 2 can be cooled to return to the room temperature by ventilation when a high temperature is applied in the constant temperature chambers 15 and 15′ or the strip formats 2 can be heated by a hot air or a heater, etc. to return to a temperature at a degree of not causing condensation when a low temperature is applied in the constant temperature chamber 15 and 15′.

Also, the above handlers 1 and 1′ may handle test trays carrying a plurality of IC devices instead of the strip formats 2.

### INDUSTRIAL APPLICABILITY

As explained above, according to the electronic device handling apparatus or the temperature application method in the electronic device handling apparatus of the present invention, the temperature application portion can be downsized and simplified and the maintainability can be improved. Namely, the present invention is useful for obtaining a compact and simple electronic device handling apparatus having good maintainability.

1. An electronic device handling apparatus capable of handling an electronic device assembly for testing electronic devices of the electronic device assembly, comprising:
a storage portion capable of storing electronic device assembly holder capable of holding a plurality of electronic device assemblies;
a temperature application portion capable of applying a predetermined temperature to electronic device assemblies held in the electronic device assembly holder; and
a holder conveyor capable of conveying the electronic device assembly holder from said storage portion to said temperature application portion.

2. The electronic device handling apparatus as set forth in claim 1, wherein said temperature application portion applies a predetermined temperature to electronic device assemblies held in an electronic device assembly holder conveyed thereto by the holder conveyor.

3. The electronic device handling apparatus as set forth in claim 2, wherein said temperature application portion is provided with a holder conveyor for conveying said electronic device assembly holder, so that an electronic device assembly holder conveyed thereto by said holder conveyor passes through said temperature application portion and is taken out from said temperature application portion.

4. The electronic device handling apparatus as set forth in claim 1, wherein said temperature application portion is provided with a temperature application electronic device assembly holder, furthermore comprising a reloading device for reloading electronic device assemblies held in a conveyor electronic device assembly holder conveyed by said holder conveyor to said temperature application electronic device assembly holder.

5. The electronic device handling apparatus as set forth in claim 4, wherein:
said electronic device assembly holder comprises an opening portion capable of letting in and out electronic device assemblies and an electronic device assembly holding portion for holding a plurality of electronic device assemblies inserted from said opening portion at predetermined pitches, and electronic device assembly holding pitches in said conveyor electronic device assembly holder and electronic device assembly holding pitches in said temperature application electronic device assembly holder are set to be substantially the same;
said holder conveyor conveys said conveyor electronic device assembly holder to a position where an opening portion of said conveyor electronic device assembly holder faces an opening portion of said temperature application electronic device assembly holder; and
said reloading device reloads electronic device assemblies held by said conveyor electronic device assembly holder by sliding them to said temperature application electronic device assembly holder.

6. The electronic device handling apparatus as set forth in any one of claims 1 to 5, wherein said electronic device assembly is a strip format, and said electronic device assembly holder is configured to be capable of holding a plurality of strip formats horizontally at predetermined pitches.

7. A temperature application method for applying a predetermined temperature to an electronic device assembly in an electronic device handling apparatus capable of handling an electronic device assembly for testing electronic devices of the electronic device assembly, comprising the steps of:
conveying electronic device assemblies to a temperature application portion by holding them in an electronic device assembly holder capable of holding a plurality of electronic device assemblies; and
applying a predetermined temperature to electronic device assemblies held in the electronic device assembly holder.

8. The temperature application method in an electronic device handling apparatus as set forth in claim 7, wherein electronic device assemblies held by the conveyor electronic device assembly holder conveyed to said temperature application portion are reloaded to a temperature application electronic device assembly holder provided to said temperature application portion, and a predetermined temperature is applied to the electronic device assemblies held by said temperature application electronic device assembly holder.
